(19) United States
(12) Patent Application Publication
(10) Pub. No.: US 2024/0210160 A1
(43) Pub. Date: Jun. 27, 2024

(54) METHOD FOR STRUCTURED ILLUMINATION MICROSCOPY AND STRUCTURED ILLUMINATION MICROSCOPE

(71) Applicant: MITUTOYO CORPORATION, Kanagawa (JP)

(72) Inventor: Bart Geert ENTINK, EINDHOVEN (NL)

(73) Assignee: MITUTOYO CORPORATION, Kanagawa (JP)

(21) Appl. No.: 18/394,552

(22) Filed: Dec. 22, 2023

(30) Foreign Application Priority Data
Dec. 27, 2022 (EP) 22216686.0

(51) Int. Cl. G01B 9/04; G01B 11/06; G02B 21/00; G02B 21/06

(52) U.S. Cl. CPC G01B 9/04; G01B 11/0608; G02B 21/002; G02B 21/06

(57) ABSTRACT

The current invention relates to a method of structured lilumination microscopy for determining a height map of a test surface wherein use is made of a structured lilumination microscope. The invention is further related to a structured illumination microscope for determining a height map of a test surface. The microscope comprises a light source, a spatial light modulator, scanner, an optical detector, and a processor.

### FIELD OF THE INVENTION

The current invention relates to a method of structured illumination microscopy for determining a height map of a test surface wherein use is made of a structured illumination microscope. The invention is further related to a structured illumination microscope for determining a height map of a test surface.

### BACKGROUND OF THE INVENTION

In known methods of structured illumination microscopy for determining a height map of a test surface a light beam is modulated to form a pattern which is projected onto the test surface. The light beam may be modulated by a spatial light modulator. During measurement, the pattern may be phase shifted in a direction perpendicular to the light beam according to the phase of the pattern to allow for determining the height of the test surface.

The kind of pattern to be used, for example fringe patterns, grid patterns, or fractal patterns, is dependent on the test surface, e.g. a flat test surface, or a curved test surface, such as a lens, and the specific instrument setup used, which dependency has an effect on the results. For example, a measurement pattern with small features may result in a high scanning-axis resolution, while a measurement pattern with large features may result in a low scanning-axis resolution.

Since the measurement with the structured illumination microscope may depend on the measurement pattern that is used, multiple measurements may be required to determine a height map of a test surface. For example, for a sloped test surface, such as a lens, multiple measurements may be required because areas with higher slope may be best measured with measurement patterns having a larger fringe width, whereas areas with a lower slope may be best measured with measurement patterns having a smaller fringe width. In another example, the test surface is tilted and patterns having periodicities along a direction of the tilt and perpendicular to the direction of the tilt may be required to determine the height map of the titled test surface.

A downside of the known methods is that errors may be introduced in determining the height map due to multiple measurements having to be performed.

### OBJECT OF THE INVENTION

The aim of the invention is to reduce errors in methods of structured illumination microscopy for determining a height map.

### SUMMARY OF THE INVENTION

The aim of the invention is achieved by the method of claim 1.

The test surface may be any test surface suitable for determining a height map thereof. For example, the test surface may be a curved test surface such as a lens. The test surface may also be tilted relative to a scanning direction of the microscope. The test surface may be opaque or transparent.

Use is made of a structured illumination microscope including a light source for emitting a light beam. For example, the light source may be a laser beam, e.g. emitting light of a specific frequency. The light source may also be a white light source, emitting light of many frequencies, e.g. emitting white light. The emitted light beam follows a light path from the light source to the test surface where it is reflected towards an optical detector.

The microscope further includes a spatial light modulator for modulating the light beam emitted by the light source. The spatial light modulator may allow for many different modulations of the light beam, such as modulations resulting in different fringe patterns, different grid patterns, or different fractal patterns. The spatial light modulator may be configured to dynamically change the modulation of the light beam.

The microscope further includes a test surface holder for holding a test surface of which a height map is to be determined. The test surface holder may hold the test surface perpendicular to a light path of the light beam or tilted relative to the light path.

A scanner is provided to direct the modulated light beam to the test surface in the test surface holder. The scanner may comprise optics for directing the light beam, such as lenses. The scanner and the test surface holder are moveable relative to each other between different scanning positions in a direction parallel to the light beam. For example, in an embodiment the test surface is perpendicular to the light beam and the scanner are moved between different heights above the test surface in a direction perpendicular to the test surface. This allows for measuring reflected light from the test surface at different positions above the test surface in the test surface holder.

The microscope further includes an optical detector for detecting a reflected light beam. The reflected light beam is reflected by the test surface provided in the test surface holder. The optical detector may be a camera adapted for measuring the reflected light beam. The reflected light beam may be directed towards the optical detector using optics for directing the light beam, such as lenses.

The microscope further includes a processor connected to the spatial light modulator, for operating the spatial light modulator, to the scanner, for operating the scanner, and to the optical detector, for operating the optical detector and receiving a measured signal of the optical detector.

The method includes providing the test surface in the test surface holder of the structured illumination microscope for determining the height map of the test surface. The method further includes emitting a light beam from the light source and modulating the emitted light beam with the spatial light modulator. The emitted light beam is modulated to generate a measurement pattern which is periodic in a direction perpendicular to the light beam and which measurement pattern has a measurement phase. The measurement phase is related to the amount of phase shifts of the pattern required to complete a full cycle of the pattern such that the pattern is the same as before performing the phase shifts.

As discussed above many different patterns may be obtained. The pattern is periodic in a direction perpendicular to the light beam. For example, the pattern may be a periodic sinusoidal pattern having straight darker and lighter lines. This pattern is periodic in a direction perpendicular to the straight darker and lighter lines, but not in a direction parallel to these lines.

The method further includes moving the scanner between the different scanning positions and modulating the light beam with the spatial light modulator such that the measurement pattern is phase shifted in the direction perpendicular to the light beam according to the measurement phase. Thus, during performing the method and measuring the reflected light beam, the measurement pattern is phase shifted such that measurements are performed for different shifts of the pattern and, additionally, for different scanning positions of the scanner. The measurement pattern is phase shifted according to the measurement pattern phase. For example, if the measurement pattern has a measurement pattern phase of n phases than the measurement pattern may be shifted n times during measurement to return the pattern to its original position.

The reflected light beam is detected with the optical detector for each scanning position and each phase shift, which results in a detected signal, e.g. in each pixel of the optical detector. The detected signal is then send to the processor for determining the height map of the test surface. The height map is determined by determining a height of the test surface, e.g. for each pixel of the optical detector, based on the detected signal. For example, the height map may be determined based on determining an amplitude of the detected signal at a corresponding signal and determining a scanning position of the scanner for which the amplitude is maximal. The scanning position for which the amplitude is maximal is then related to the height of the test surface at the respective pixel.

The light beam is modulated such that the measurement pattern is a superposition of at least a first periodic pattern having a first phase and a second periodic pattern having a second phase. The first phase and the second phase are different from each other. The measurement pattern phase is an integer multiple of the least common multiple of the first phase and the second phase. For example, the first phase may be a 3 phase and the second phase may be a 4 phase in which case the measurement pattern phase is a 12 phase requiring 12 phase shifts to complete a full cycle.

Thus, the measurement pattern is a superposition of at least two different patterns and the measurement pattern is shifted according to the phase shifts of the superposed patterns. By appropriately choosing the first periodic pattern and the second periodic pattern the resulting measurement pattern may have improved characteristics for determining a height map of the test surface compared to a randomly chosen measurement pattern. For example, the measurement pattern may be a superposition of a first periodic pattern having a large fringe width and a second periodic pattern having a small fringe width to allow for simultaneous measurement of areas of a test surface having higher slopes and lower slopes. Thus, a single measurement cycle is needed to measure the test surface and errors resulting from performing multiple measurement cycles with multiple measurement patterns are reduced.

In embodiments, the determining of the height map further includes, for each pixel of the optical detector:
performing a Fourier transformation on the detected signal transforming the detected signal to frequency space;
separating the detected signal into a first presignal related to the first periodic pattern and a second presignal related to the second periodic pattern;
performing an inverse Fourier transformation on each of the first presignal and the second presignal;
determining a first premap by determining a height of the test surface based on the first presignal, e.g. by determining a first amplitude of the first signal at each pixel and determining a scanning position wherein the first amplitude is maximal;
determining a second premap by determining a height of the test surface based on the second presignal, e.g. by determining a second amplitude of the second presignal at each pixel and determining a scanning position wherein the second amplitude is maximal; and
determining the height map based on the first premap and the second premap.

An advantage of using a measurement pattern that is a superposition of two periodic patterns having different phases is that the detected signal may be separated in frequency space in a first presignal arising from the periodic pattern having the first phase and a second presignal arising from the second pattern having the second phase. Thus by performing a Fourier transformation on the detected signal the detected signal may be separated into the first presignal, related to the first periodic pattern, and the second presignal, related to the second periodic pattern. An inverse Fourier transformation may then be performed independently on each of the first presignal and the second presignal to obtain a first presignal in coordinate space, related to the first periodic pattern, and a second presignal in coordinate space, related to the second periodic pattern. For each presignal a premap may be determined wherein using the first periodic pattern may result in a first premap having first characteristics and using the second periodic pattern may have result in a second premap having second characteristics. The height map is then determined based on the first premap and the second premap. The resulting height map may have advantageous characteristics of the first premap and the second premap.

A potential downside of determining a height map using structured illumination microscopy is a longer throughput time, which may increase due to a larger amount of phase shifts required. In embodiments, the throughput time is reduced by taking, at each scanning position only a single image and wherein the measurement pattern is phase shifted with a single phase between scanning positions. The height map in these embodiments may be determined based on determining an amplitude of the detected signal at the corresponding pixel and determining a scanning position wherein the amplitude is maximal. The scanning position wherein the amplitude is maximal is the scanning position wherein the test surface is in focus of the microscope which allows to determine the height map.

In embodiments, the measurement pattern, the first periodic pattern, and/or the second periodic pattern is a sinusoidal periodic pattern, a binary strip pattern, or a periodic circular pattern.

In embodiments, the first periodic pattern has a larger fringe width and the second periodic pattern has a smaller fringe width.

In embodiments, the first periodic pattern is periodic in a first direction parallel to the test surface and the second periodic pattern is periodic in a second direction parallel to the test surface, e.g. wherein the first direction is perpendicular to the second direction, and wherein phase shifting includes phase shifting the measurement pattern in the first direction parallel to the test surface and in the second direction parallel to the test surface according to the respective phases.

The invention further relates to a structured illumination microscope for determining a height map of a test surface including:
a light source for emitting a light beam;
a spatial light modulator for modulating the light beam emitted by the light source;
a test surface holder for holding a test surface;
scanner to direct the modulated light beam to the test surface in the test surface holder, wherein the scanner and the test surface holder are movable relative to each other between different scanning positions in a direction parallel to the light beam;
an optical detector for detecting a reflected light beam reflected by a test surface provided in the test surface holder; and
a processor connected to the spatial light modulator, the scanner, and the optical detector,
   wherein the microscope is configured to, when the test surface is provided in the test surface holder:
emit a light beam from the light source and modulate the light beam emitted by the light source with the spatial light modulator to generate a measurement pattern which is periodic in a direction perpendicular to the light beam and which measurement pattern has a measurement pattern phase;
direct the modulated light beam to the test surface with the scanner;
move the scanner between the different scanning positions and modulating the light beam with the spatial light modulator such that the measurement pattern is phase shifted in the direction perpendicular to the light beam according to the measurement pattern phase;
detect the reflected light beam for each scanning position and each phase shift with the optical detector resulting in a detected signal in each pixel of the optical detector; and
determine, by the processor, a height map of the test surface by determining a height of the test surface based on the detected signal, e.g. based on determining an amplitude of the detected signal at the corresponding pixel and determining a scanning position wherein the amplitude is maximal,
   wherein the light beam is modulated such that the measurement pattern is a superposition of at least a first periodic pattern having a first phase and a second periodic pattern having a second phase, wherein the first phase and the second phase are different from each other, and wherein the measurement pattern phase is an integer multiple of the least common multiple of the first phase and the second phase.

In embodiments of the microscope, the processor is configured to, when determining the height map, for each pixel of the optical detector:
perform a Fourier transformation on the detected signal transforming the detected signal to frequency space;
separate the detected signal into a first presignal related to the first periodic pattern and a second presignal related to the second periodic pattern;
perform an inverse Fourier transformation on each of the first presignal and the second presignal;
determine a first premap by determining a height of the test surface based on the first presignal, e.g. by determining a first amplitude of the first signal at each pixel and determine a scanning position wherein the first amplitude is maximal;
determining a second premap by determining a height of the test surface based on the presecond signal, e.g. by determining a second amplitude of the second signal at each pixel and determining a scanning position wherein the second amplitude is maximal; and
determine the height map based on the first premap and the second premap.

In embodiments of the microscope, the microscope is configured to take only a single image at each scanning position and wherein the microscope is configured to phase shift the measurement with a single phase between scanning positions.

In embodiments of the microscope, the first periodic pattern, and/or the second periodic pattern is a sinusoidal periodic pattern, a binary strip pattern, or a periodic circular pattern.

In embodiments of the microscope, the first periodic pattern has a larger fringe width and the second periodic pattern has a smaller fringe width.

In embodiments of the microscope, the first periodic pattern is periodic in a first direction parallel to the test surface and the second periodic pattern is periodic in a second direction parallel to the test surface, e.g. wherein the first direction is perpendicular to the second direction, and wherein the structured illumination microscope is configured to phase shift the measurement pattern in the first direction parallel to the test surface and in the second direction parallel to the test surface according to the respective phases.

### BRIEF DESCRIPTION OF THE DRAWINGS

The invention will now be explained with reference to the drawing, in which:

FIG. 1 shows a structured illumination microscope;

FIG. 2 shows a first periodic pattern, a second periodic pattern, and a resulting superposed pattern; and

FIG. 3 shows a Fourier transformed detected signal.

### DESCRIPTION OF EMBODIMENTS

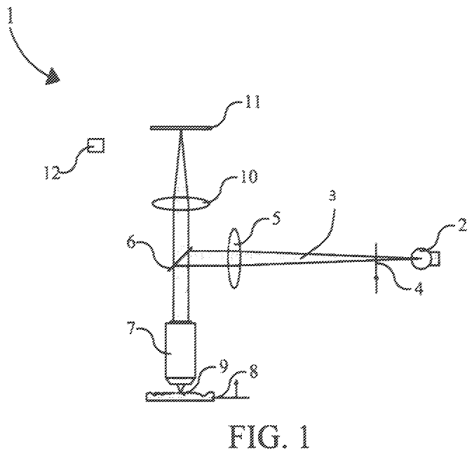

FIG. 1 shows a structured illumination microscope 1 having a light source 2 for emitting a light beam 3. The structured illumination microscope 1 is configured for determining a height map of the test surface 8.

The light beam 3 emitted by the light source 2 is modulated by the spatial light modulator 4. The spatial light modulator 4 is configured to modulate the light beam 3 to generate a measurement pattern which is periodic in a direction perpendicular to the light beam 3. The thus generated measurement pattern has a measurement pattern phase which is a superposition of at least a first periodic pattern having a first phase and a second periodic pattern having a second phase. For example, the first phase may be a 3 phase and the second phase may be a 4 phase, such that the measurement pattern has a 12 phase.

The light beam is directed by the lens 5 and the reflective element 6 towards the scanner 7 which direct the light beam 3 to the test surface 8 in the test surface holder. The test surface 8 and the scanner 7 are moveable relative to each other between different scanning positions in a direction parallel to the light beam 3. The scanner 7 may direct the light beam 3 towards the test surface 8 to test point 9 to measure the height thereof.

The test surface 8 reflects the light beam 3 via reflector 6 and lens 10 towards the optical detector 11 for detecting the reflected light beam 3. The processor 12 is connected to the optical detector 11, for determining the height map.

The microscope 1 is configured to, when the test surface 8 is provided in the test surface holder:
emit the light beam 3 from the light source 2 and modulate the light beam 3 emitted by the light source 2 with the spatial light modulator 4 to generate a measurement pattern which is periodic in a direction perpendicular to the light beam 3 and which measurement pattern has a measurement pattern phase;
direct the modulated light beam 3 to the test surface 8 with the scanner 7;
move the scanner 7 between the different scanning positions and modulating the light beam 3 with the spatial light modulator 4 such that the measurement pattern is phase shifted in the direction perpendicular to the light beam 3 according to the measurement pattern phase; detect the reflected light beam 3 for each scanning position and each phase shift with the optical detector 11 resulting in a detected signal in each pixel of the optical detector 11; and
determine, by the processor 12, a height map of the test surface 8 by determining a height of the test surface 8 based on the detected signal, e.g. based on determining an amplitude of the detected signal at the corresponding pixel and determining a scanning position wherein the amplitude is maximal.

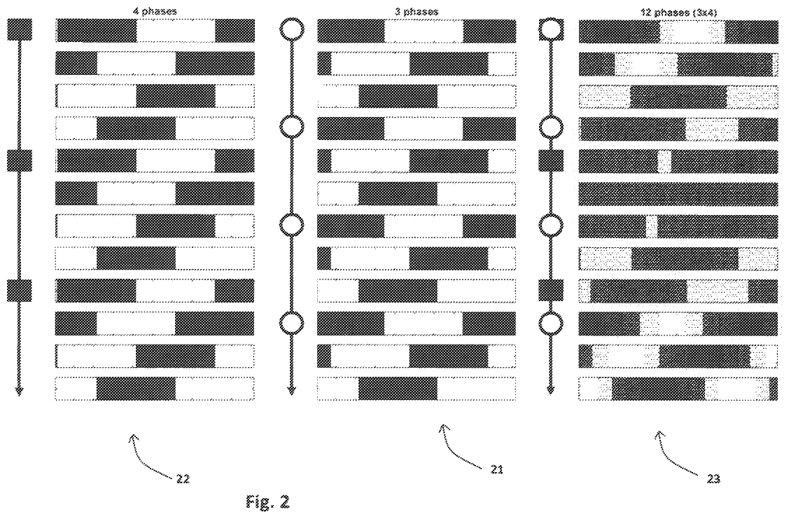

FIG. 2 shows a first periodic pattern 21 having a three phase, a second periodic pattern 22 having a four phase, and a resulting superposed pattern 23 having a twelve phase. As can be seen from the figure the first periodic pattern 21 has to be shifted three times before a cycle is completed, i.e. after three phase shifts, the first periodic pattern 21 returns to the unshifted first periodic pattern 21. Similarly, the second periodic pattern 22 having the four phase has to be shifted four times before a cycle is completed.

The resulting superimposed pattern 23 is a superposition of the three phase pattern 21 and the four phase pattern 22 and has a resulting twelve phase. Thus the measurement pattern, which is the superimposed pattern, 23 has to be shifted twelve times before the cycle is completed.

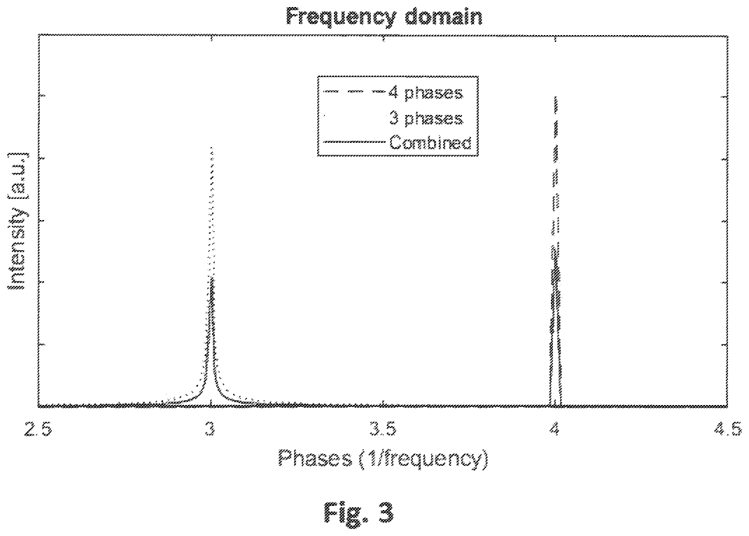

FIG. 3 shows the separatable signal after Fourier transformation obtained from a measurement of the measurement pattern 23, wherein the signal has a twelve phase. FIG. 3 further shows a detected signal if only the three phase pattern 21 were used and a detected signal if only the four phase pattern 22 were used.

As can be seen in FIG. 3, the measurement pattern 23 contains information from both the first periodic pattern 21 and the second periodic pattern 22. Thus the measurement pattern 23 may be used to determine a height map instead of using separately the three phase pattern 21 and the four phase 22. Since the measurement does not have to be repeated for different patterns, errors resulting from performing multiple measurements may be reduced and the resulting height map may be more accurate. Other periodic patterns having other phases or characteristics, such as a repeated square pattern, a circular symmetric pattern, may equally be used in the method.

What is claimed is:

1. A method for determining a height map of a test surface wherein use is made of a structured illumination microscope having:
a light source for emitting a light beam;
a spatial light modulator for modulating the light beam emitted by the light source;
a test surface holder for holding a test surface;
scanner to direct the modulated light beam to the test surface in the test surface holder, wherein the scanner and the test surface holder are movable relative to each other between different scanning positions in a direction parallel to the light beam;
an optical detector for detecting a reflected light beam reflected by a test surface provided in the test surface holder; and
a processor connected to the optical detector,
wherein the method comprises:
providing the test surface in the test surface holder of the structured illumination microscope;
emitting a light beam from the light source and modulating the light beam emitted by the light source with the spatial light modulator to generate a measurement pattern which is periodic in a direction perpendicular to the light beam and which measurement pattern has a measurement pattern phase;
directing the modulated light beam to the test surface with the scanner;
moving the scanner between the different scanning positions and modulating the light beam with the spatial light modulator such that the measurement pattern is phase shifted in the direction perpendicular to the light beam according to the measurement pattern phase;
detecting the reflected light beam for each scanning position and each phase shift with the optical detector resulting in a detected signal; and
determining a height map of the test surface, by the processor, by determining a height of the test surface based on the detected signal,
wherein the light beam is modulated such that the measurement pattern is a superposition of at least a first periodic pattern having a first phase and a second periodic pattern having a second phase, wherein the first phase and the second phase are different from each other, and wherein the measurement pattern phase is an integer multiple of the least common multiple of the first phase and the second phase.

2. The method according to claim 1, wherein the determining of the height map further comprises, for each pixel of the optical detector:
performing a Fourier transformation on the detected signal transforming the detected signal to frequency space;
separating the detected signal into a first presignal related to the first periodic pattern and a second presignal related to the second periodic pattern;
performing an inverse Fourier transformation on each of the first presignal and the second presignal;
determining a first premap by determining a height of the test surface based on the first presignal;
determining a second premap by determining a height of the test surface based on the second presignal; and
determining the height map based on the first map and the second map.

3. The method according to claim 1, wherein at each scanning position only a single image is taken and wherein the measurement pattern is phase shifted with a single phase between scanning positions.

4. The method according to claim 1, wherein the measurement pattern, the first periodic pattern, and/or the second periodic pattern is a sinusoidal periodic pattern, a binary strip pattern, or a periodic circular pattern.

5. The method according to claim 1, wherein the first periodic pattern has a larger fringe width and the second periodic pattern has a smaller fringe width.

6. The method according to claim 1, wherein the first periodic pattern is periodic in a first direction parallel to the test surface and the second periodic pattern is periodic in a second direction parallel to the test surface, and wherein phase shifting comprises phase shifting the measurement pattern in the first direction parallel to the test surface and in the second direction parallel to the test surface according to the respective phases.

7. A structured illumination microscope for determining a height map of a test surface comprising:
a light source for emitting a light beam;
a spatial light modulator for modulating the light beam emitted by the light source;
a test surface holder for holding a test surface;
scanner to direct the modulated light beam to the test surface in the test surface holder, wherein the scanner and the test surface holder are movable relative to each other between different scanning positions in a direction parallel to the light beam;
an optical detector for detecting a reflected light beam reflected by a test surface provided in the test surface holder; and
a processor connected to the spatial light modulator, the scanner, and the optical detector, wherein the microscope is configured to, when the test surface is provided in the test surface holder, comprises:
emit a light beam from the light source and modulate the light beam emitted by the light source with the spatial light modulator to generate a measurement pattern which is periodic in a direction perpendicular to the light beam and which measurement pattern has a measurement pattern phase;
direct the modulated light beam to the test surface with the scanner;
move the scanner between the different scanning positions and modulating the light beam with the spatial light modulator such that the measurement pattern is phase shifted in the direction perpendicular to the light beam according to the measurement pattern phase;
detect the reflected light beam for each scanning position and each phase shift with the optical detector resulting in a detected signal; and
determine, by the processor, a height map of the test surface by determining a height of the test surface based on the detected signal,
wherein the light beam is modulated such that the measurement pattern is a superposition of at least a first periodic pattern having a first phase and a second periodic pattern having a second phase, wherein the first phase and the second phase are different from each other, and wherein the measurement pattern phase is an integer multiple of the least common multiple of the first phase and the second phase.

8. The structured illumination microscope according to claim 7, wherein the processor is configured to, when determining the height map, for each pixel of the optical detector:
perform a Fourier transformation on the detected signal transforming the detected signal to frequency space;
separate the detected signal into a first presignal related to the first periodic pattern and a second presignal related to the second periodic pattern;
perform an inverse Fourier transformation on each of the first presignal and the second presignal;
determine a first premap by determining a height of the test surface based on the first presignal;
determining a second premap by determining a height of the test surface based on the presecond signal; and
determine the height map based on the first premap and the second premap.

9. The structured illumination microscope according to claim 7, wherein the microscope is configured to take only a single image at each scanning position and wherein the microscope is configured to phase shift the measurement with a single phase between scanning positions.

10. The structured illumination microscope according to claim 7, the first periodic pattern, and/or the second periodic pattern is a sinusoidal periodic pattern, a binary strip pattern, or a periodic circular pattern.

11. The structured illumination microscope according to claim 7, wherein the first periodic pattern has a larger fringe width and the second periodic pattern has a smaller fringe width.

12. The structured illumination microscope according to claim 7, wherein the first periodic pattern is periodic in a first direction parallel to the test surface and the second periodic pattern is periodic in a second direction parallel to the test surface, and wherein the structured illumination microscope is configured to phase shift the measurement pattern in the first direction parallel to the test surface and in the second direction parallel to the test surface according to the respective phases.
